(19) United States
(12) Patent Application Publication
(10) Pub. No.: US 2023/0325220 A1
(43) Pub. Date: Oct. 12, 2023

(54) HOSTING DPU MANAGEMENT OPERATING SYSTEM USING DPU SOFTWARE STACK

(71) Applicant: VMware, Inc., Palo Alto, CA (US)

(72) Inventors: Andrei Warkentin, South Elgin, IL (US); Sunil Kotian, San Jose, CA (US); Cyprien Laplace, Boston, MA (US); Shruthi Hiriyuru, Medford, MA (US); Regis Duchesne, Monts-de-Corsier (CH); Ye Li, Newton Highlands, MA (US); Alexander Fainkichen, Southborough, MA (US)

(21) Appl. No.: 17/715,283

(22) Filed: Apr. 7, 2022

(51) Int. Cl. G06F 9/455

(52) U.S. Cl. CPC G06F 9/45537

(57) ABSTRACT

Disclosed are various examples of hosting a data processing unit (DPU) management operating system using an operating system software stack of a preinstalled DPU operating system. The preinstalled DPU operating system of the DPU is leveraged to provide a virtual machine environment. A DPU management operating system is executed within the virtual machine environment of the preinstalled DPU operating system. A third-party DPU function or a management service function is provided using the DPU hardware resources accessed through the DPU management operating system and the virtual machine environment.

### BACKGROUND

Enterprises can employ a management service that uses virtualization to provide the enterprise with access to software, data, and other resources. The management service use host devices to execute workloads that provide software services for enterprise activities. The enterprises can use other host devices to access these workloads.

Data processing units (DPUs) can be physically installed to various host devices. These DPUs can include processors, a network interface, and in many cases can include acceleration engines capable of machine learning, networking, storage, and artificial intelligence processing. The DPUs can include processing, networking, storage, and accelerator hardware. However, DPUs can be made by a wide variety of manufacturers. The interface and general operation can differ from DPU to DPU.

This can pose problems for management services and enterprises that desire to fully utilize the capabilities of DPUs in the host devices. There is a need for better mechanisms that can integrate DPUs into a virtualization and management solution.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment that includes components that host a data processing unit (DPU) management operating system virtual machine using a preinstalled DPU software stack, according to the present disclosure.

FIG. 2 is a drawing of an example of a DPU device that hosts a DPU management operating system virtual machine using a preinstalled DPU software stack, according to the present disclosure.

FIG. 3 is a flowchart illustrating functionality implemented by components of the networked environment, according to the present disclosure.

### DETAILED DESCRIPTION

The present disclosure relates to hosting a data processing unit (DPU) management operating system using a preinstalled DPU operating system software stack. The Preinstalled DPU operating system can include any operating system installed by a third party to. A DPU can be physically installed to a host device. The DPU can include processors, a network interface, and in many cases can include acceleration engines capable of machine learning, networking, storage, and artificial intelligence processing. However, DPUs can be made by a wide variety of manufacturers. The interface and general operation can differ from DPU to DPU. This can pose problems for management services and enterprises that desire to fully utilize the capabilities of DPUs in host devices. If a management service replaces a provider DPU operating system with a DPU management operating system, some of the native functionality can be lost. However, the present disclosure describes mechanisms that can host a DPU management operating system using a preinstalled DPU software stack. This enables concurrent execution of the provider DPU operating system and the DPU management operating system from the management service.

DPU devices can be vertically integrated solutions, with a tight coupling of custom hardware and manufacturer-specific, vendor-specific, or other third-party software that is a third-party with respect to a management service. The DPU hardware has no requirement to be built to particular standard. DPU devices can use off-the-shelf IP circuit blocks for flash memories, Universal Asynchronous Receiver/Transmitter (UART) devices, peripheral component interconnect express (PCIe) devices, and others. Some of the circuit blocks used for DPU devices can cause driver problems from their relatively lower industry adoption rate.

A DPU management operating system image can require many customized drivers and other specialized codes for each supported DPU, if used as a replacement operating system for multiple different DPUs. Customers can desire to use both management service provided functionalities and third-party services. The present disclosure provides mechanisms that can launch a DPU management operating system inside a specially tailored virtual machine environment that is provided using a Preinstalled DPU operating system software stack.

The environment can model a SystemReady Embedded Server (ES) environment and present a set of desired offloads using pass-thru technologies including PCIe PassThrough (PT), single root I/O virtualization (SR-IOV), and other passthrough technologies. This can prevent waiting for provider firmware, pulling in CPU/chipset quirks, developing drivers for non-standard hardware such as on-board flash storage drivers, Gigabit Ethernet (GbE) management networking, UART, watchdog, and others. Hardware utilized by the DPU management operating system such as application-specific integrated circuit (ASIC) hardware can be passed through by the virtual machine environment launched from the provider operating system. Native DPU services can be left within a native or preinstalled operating system. A management agent that deploys and updates the DPU management operating system can be executed within the third party preinstalled operating system, simplifying lifecycle considerations.

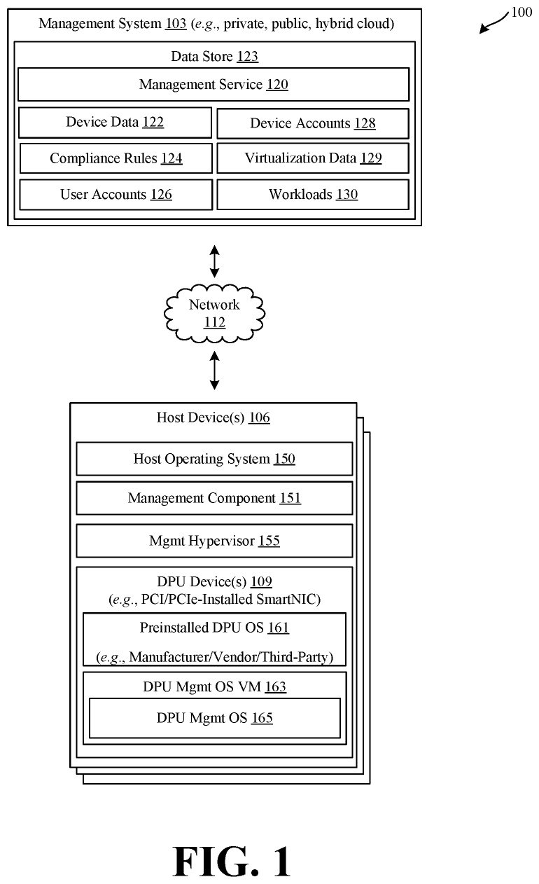

With reference to FIG. 1, shown is an example of a networked environment 100. The networked environment 100 can include a management system 103, host devices 106, and other components in communication with one another over a network 112. DPU devices 109 can be installed to the host devices 106. In some cases, host devices 106 can include computing devices or server computing devices of a private cloud, public cloud, hybrid cloud, and multi-cloud infrastructures. Hybrid cloud infrastructures can include public and private host computing devices. Multi-cloud infrastructures can include multiple different computing platforms from one or more service providers in order to perform a vast array of enterprise tasks.

The host devices 106 can also include devices that can connect to the network 112 directly or through an edge device or gateway. The components of the networked environment 100 can be utilized to provide virtualization solutions for an enterprise. The hardware of the host devices 106 can include physical memory, physical processors, physical data storage, and physical network resources that can be utilized by virtual machines. Host devices 106 can also include peripheral components such as the DPU devices 109. The host devices 106 can include physical memory, physical processors, physical data storage, and physical network resources. Virtual memory, virtual processors, virtual data storage, and virtual network resources of a virtual machine can be mapped to physical memory, physical processors, physical data storage, and physical network resources of the host devices 106. The management hypervisor 155 can provide access to the physical memory, physical processors, physical data storage, and physical network resources of the host devices 106 to perform workloads 130.

The DPU devices 109 can include networking accelerator devices, smart network interface cards, or other cards that are installed as a peripheral component. The DPU devices 109 themselves can also include physical memory, physical processors, physical data storage, and physical network resources. The DPU devices 109 can also include specialized physical hardware that includes accelerator engines for machine learning, networking, storage, and artificial intelligence processing. Virtual memory, virtual processors, virtual data storage, and virtual network resources of a virtual machine can be mapped to physical memory, physical processors, physical data storage, physical network resources, and physical accelerator resources of the DPU devices 109.

The DPU management operating system 165 can communicate with the management hypervisor 155 and/or with the management service 120 directly to provide access to the physical memory, physical processors, physical data storage, physical network resources, and physical accelerator resources of the DPU devices 109. However, the DPU management operating system 165 may not be initially installed to the DPU device 109.

Virtual devices including virtual machines, containers, and other virtualization components can be used to execute the workloads 130. The workloads 130 can be managed by the management service 120 for an enterprise that employs the management service 120. Some workloads 130 can be initiated and accessed by enterprise users through client devices. The virtualization data 129 can include a record of the virtual devices, as well as the host devices 106 and DPU devices 109 that are mapped to the virtual devices. The virtualization data 129 can also include a record of the workloads 130 that are executed by the virtual devices.

The network 112 can include the Internet, intranets, extranets, wide area networks (WANs), local area networks (LANs), wired networks, wireless networks, other suitable networks, or any combination of two or more such networks. The networks can include satellite networks, cable networks, Ethernet networks, telephony networks, and other types of networks.

The management system 103 can include one or more host or server computers, and any other system providing computing capability. In some examples, a subset of the host devices 106 can provide the hardware for the management system 103. While referred to in the singular, the management system 103 can include a plurality of computing devices that are arranged in one or more server banks, computer banks, or other arrangements. The management system 103 can include a grid computing resource or any other distributed computing arrangement. The management system 103 can be multi-tenant, providing virtualization and management of workloads 130 for multiple different enterprises. Alternatively, the management system 103 can be customer or enterprise-specific.

The computing devices of the management system 103 can be located in a single installation or can be distributed among many different geographical locations which can be local and/or remote from the other components. The management system 103 can also include or be operated as one or more virtualized computer instances. For purposes of convenience, the management system 103 is referred to herein in the singular. Even though the management system 103 is referred to in the singular, it is understood that a plurality of management systems 103 can be employed in the various arrangements as described above.

The components executed on the management system 103 can include a management service 120, as well as other applications, services, processes, systems, engines, or functionality not discussed in detail herein. The management service 120 can be stored in the data store 123 of the management system 103. While referred to generally as the management service 120 herein, the various functionalities and operations discussed can be provided using a management service 120 that includes a scheduling service and a number of software components that operate in concert to provide compute, memory, network, and data storage for enterprise workloads and data. The management service 120 can also provide access to the enterprise workloads and data executed by the host devices 106 and can be accessed using client devices that can be enrolled in association with a user account 126 and related credentials.

The management service 120 can communicate with associated management instructions executed by host devices 106, client devices, edge devices, and IoT devices to ensure that these devices comply with their respective compliance rules 124, whether the specific host device 106 is used for computational or access purposes. If the host devices 106 or client devices fail to comply with the compliance rules 124, the respective management instructions can perform remedial actions including discontinuing access to and processing of workloads 130.

The data store 123 can include any storage device or medium that can contain, store, or maintain the instructions, logic, or applications described herein for use by or in connection with the instruction execution system. The data store 123 can be a hard drive or disk of a host, server computer, or any other system providing storage capability. While referred to in the singular, the data store 123 can include a plurality of storage devices that are arranged in one or more hosts, server banks, computer banks, or other arrangements. The data store 123 can include any one of many physical media, such as magnetic, optical, or semiconductor media. More specific examples include solid-state drives or flash drives. The data store 123 can include a data store 123 of the management system 103, mass storage resources of the management system 103, or any other storage resources on which data can be stored by the management system 103. The data store 123 can also include memories such as RAM used by the management system 103. The RAM can include static RAM (SRAM), dynamic RAM (DRAM), synchronous DRAM (SDRAM), and other types of RAM.

The data stored in the data store 123 can include management data including device data 122, enterprise data, compliance rules 124, user accounts 126, and device accounts 128, as well as other data. Device data 122 can identify host devices 106 by one or more device identifiers, a unique device identifier (UDID), a media access control (MAC) address, an internet protocol (IP) address, or another identifier that uniquely identifies a device with respect to other devices.

The device data 122 can include an enrollment status indicating whether a computing device, including a DPU device, is enrolled with or managed by the management service 120. For example, an end-user device, an edge device, IoT device, host device 106, client device, or other devices can be designated as “enrolled” and can be permitted to access the enterprise workloads and data hosted by host devices 106, while those designated as “not enrolled,” or having no designation, can be denied access to the enterprise resources. The device data 122 can further include indications of the state of IoT devices, edge devices, end user devices, host devices 106, DPU devices 109 and other devices. For example, the device data 122 can indicate that a host device 106 includes a DPU device 109 that has a DPU management operating system 165 installed. This can enable providing remotely-hosted management services to the host device 106 through or using the DPU device 109. This can also include providing management services to other remotely-located client or host devices 106 using resources of the DPU device 109. While a user account 126 can be associated with a particular person as well as client devices, a device account 128 can be unassociated with any particular person, and can nevertheless be utilized for an IoT device, edge device, or another client device that provides automatic functionalities.

Device data 122 can also include data pertaining to user groups. An administrator can specify one or more of the host devices 106 as belonging to a user group. The user group can refer to a group of user accounts 126, which can include device accounts 128. User groups can be created by an administrator of the management service 120.

Compliance rules 124 can include, for example, configurable criteria that must be satisfied for the host devices 106, DPU devices 109, and other devices to be in compliance with the management service 120. The compliance rules 124 can be based on a number of factors, including geographical location, activation status, enrollment status, and authentication data, including authentication data obtained by a device registration system, time, and date, and network properties, among other factors associated with each device. The compliance rules 124 can also be determined based on a user account 126 associated with a user.

Compliance rules 124 can include predefined constraints that must be met in order for the management service 120, or other applications, to permit host devices 106 and other devices access to enterprise data and other functions of the management service 120. The management service 120 can communicate with management instructions on the client device to determine whether states exist on the client device which do not satisfy one or more of the compliance rules 124. States can include, for example, a virus or malware being detected; installation or execution of a blacklisted application; and/or a device being “rooted” or “jailbroken,” where root access is provided to a user of the device. Additional states can include the presence of particular files, questionable device configurations, vulnerable versions of applications, vulnerable states of the client devices or other vulnerability, as can be appreciated. While the client devices can be discussed as user devices that access or initiate workloads 130 that are executed by the host devices 106, all types of devices discussed herein can also execute virtualization components and provide hardware used to host workloads 130.

The management service 120 can oversee the management and resource scheduling using hardware provided using host devices 106 and DPU devices 109. The management service 120 can oversee the management and resource scheduling of services that are provided to the host devices 106 and DPU devices 109 using remotely located hardware. The management service 120 can transmit various software components, including enterprise workloads, enterprise data, and other enterprise resources for processing and storage using the various host devices 106. The host devices 106 can include host devices 106 such as a server computer or any other system providing computing capability, including those that compose the management system 103. Host devices 106 can include public, private, hybrid cloud and multi-cloud devices that are operated by third parties with respect to the management service 120. The host devices 106 can be located in a single installation or can be distributed among many different geographical locations which can be local and/or remote from the other components.

The host devices 106 can include DPU devices 109 that are connected to the host device 106 through a universal serial bus (USB) connection, a Peripheral Component Interconnect Express (PCI-e) or mini-PCI-e connection, or another physical connection. DPU devices 109 can include hardware accelerator devices specialized to perform artificial neural networks, machine vision, machine learning, and other types of special purpose instructions written using CUDA, OpenCL, C++, and other instructions. The DPU devices 109 can utilize in-memory processing, low-precision arithmetic, and other types of techniques. The DPU devices 109 can have hardware including a network interface controller (NIC), CPUs, data storage devices, memory devices, and accelerator devices.

The management service 120 can include a scheduling service that monitors resource usage of the host devices 106, and particularly the host devices 106 that execute enterprise workloads 130. The management service 120 can also track resource usage of DPU devices 109 that are installed on the host devices 106. The management service 120 can track the resource usage of DPU devices 109 in association with the host devices 106 to which they are installed. The management service 120 can also track the resource usage of DPU devices 109 separately from the host devices 106 to which they are installed.

In some examples, the DPU devices 109 can execute workloads 130 assigned to execute on host devices 106 to which they are installed. For example, the management hypervisor 155 can communicate with a DPU management operating system 165 to offload all or a subset of a particular workload 130 to be performed using the hardware resources of a DPU device 109. Alternatively, the DPU devices 109 can execute workloads 130 assigned, by the management service 120, specifically to the DPU device 109 or to a virtual device that includes the hardware resources of a DPU device 109. In some examples, the management service 120 can communicate directly with the DPU management operating system 165, and in other examples the management service 120 can use the management hypervisor 155 to communicate with the DPU management operating system 165. The management service 120 can use DPU devices 109 to provide the host device 106 with access to workloads 130 executed using the hardware resources of another host device 106 or DPU device 109.

The host device 106 can execute instructions including a host operating system 150, a management component 151 and a management hypervisor 155. The DPU device 109 can execute instructions including a preinstalled DPU operating system 161, a DPU management operating system virtual machine, and a DPU management operating system 165.

The host operating system 150 can include an operating system that provides a user interface and an environment for applications and other instructions executed by the host device 106. The host operating system 150 can include any operating system. In some examples, the host operating system 150 can include a server operating system such as Windows Server® or another operating system for server computers.

The management component 151 can communicate with the management service 120 for scheduling of workloads 130 executed using virtual resources that are mapped to the physical resources of one or more host device 106. The management component 151 can communicate with the management hypervisor 155 to deploy virtual devices that perform the workloads 130. In various embodiments, the management component 151 can be separate from, or a component of, the management hypervisor 155. The management component 151 can additionally or alternatively be installed to the DPU device 109. The management component 151 of a DPU device 109 can be separate from, or a component of, the DPU management operating system 165.

The management hypervisor 155 can include a bare metal or type 1 hypervisor that can provide access to the physical memory, physical processors, physical data storage, and physical network resources of the host devices 106 to perform workloads 130. A management hypervisor 155 can create, configure, reconfigure, and remove virtual machines and other virtual devices on a host device 106. The management hypervisor 155 can also relay instructions from the management service 120 to the DPU management operating system 165. In other cases, the management service 120 can communicate with the DPU management operating system 165 directly. The management hypervisor 155 can identify that a workload 130 or a portion of a workload 130 includes instructions that can be executed using the DPU device 109, and can offload these instructions to the DPU device 109.

The preinstalled DPU operating system 161 can include a third-party installed operating system that is preinstalled and packaged along with the DPU device 109, for example, by a manufacturer, vendor, another provider or another third-party. The preinstalled DPU operating system 161 can be a customized, bespoke, or proprietary version of an operating system. A preinstalled DPU software stack can include the preinstalled DPU operating system 161 as well as native DPU functions or functionalities that perform network, compute, storage, artificial intelligence, machine learning, and other types of functionalities that are designed by a DPU provider or another third party with respect to the management service. The native DPU functions can be part of the preinstalled DPU operating system 161, and can also include separate instructions executed in an environment provided using the preinstalled DPU operating system 161. The preinstalled DPU operating system 161 can provide endpoints through which the native DPU functions can be invoked for use.

The DPU management operating system virtual machine 163 can include a virtual machine that executes the DPU management operating system 165. The DPU management operating system virtual machine 163 can access DPU hardware resources using kernel-space DPU virtualization from the DPU provider operating system. The DPU management operating system virtual machine 163 can also utilize user-space emulation facilities that emulate specialized hardware of the DPU that is not virtualized by the DPU provider operating system stack. The DPU management operating system virtual machine 163 can include a privileged virtual machine that operates at a kernel level and has access to kernel level privileges of the DPU device 109. This can remove the need for and omit an input-output memory management unit (IOMMU) to protect or isolate the preinstalled DPU operating system 161 from the DPU management operating system 165, and to hide bus/cpu address translations.

The DPU management operating system 165 can include a management-service-specific operating system that enables the management service 120 to manage the DPU device 109 and assign workloads 130 to execute using its resources. The DPU management operating system 165 can communicate with the management component 151, the management hypervisor 155 and/or with the management service 120 directly to provide access to the physical memory, physical processors, physical data storage, physical network resources, and physical accelerator resources of the DPU devices 109.

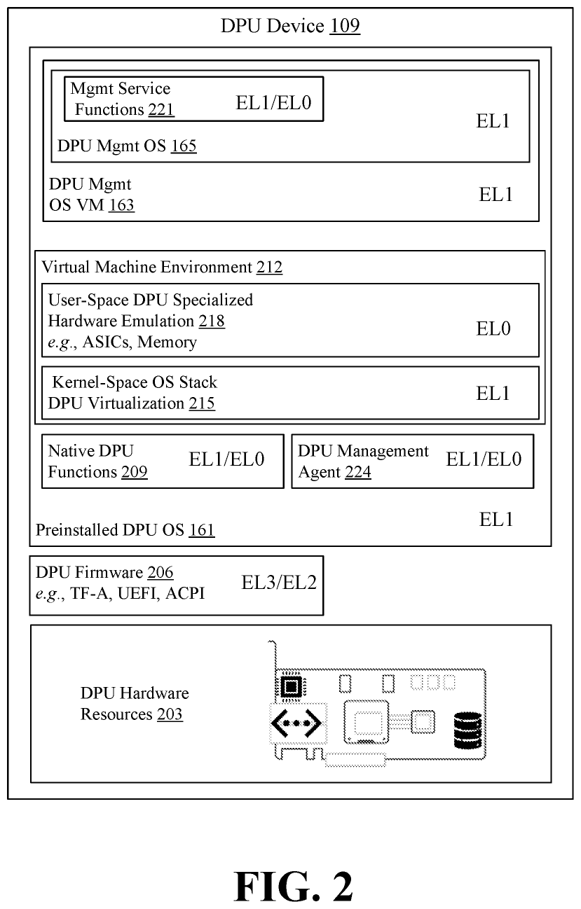

FIG. 2 shows an example of the DPU device 109 that hosts the DPU management operating system 165 using a DPU provider software stack. The DPU device 109 can include DPU hardware resources 203, DPU firmware 206, the preinstalled DPU operating system 161, a virtual machine environment 212, and a DPU management operating system virtual machine 163.

The DPU hardware resources 203 can include a main processor such as an ARM processor or another RISC-based processor, one or more memory including flash, Non-Volatile Memory Express (NVMe) devices, and others memory devices. The DPU hardware resources 203 can include specialized ASICs including network interface card (NIC) ASICs, network processing units (NPU) ASICs, field programmable gate array (FPGA) based ASICs, software switches, Programming Protocol-independent Packet Processors (P4) devices, NVIDIA® ConnectX®-6 Dx (CX6) devices, and others. In some examples the main processor can be virtualized using a kernel-space operating system stack DPU virtualization 215 of a kernel space or user space software stack provided by the preinstalled DPU operating system 161. In some examples, all DPU hardware resources 203 can be virtualized using kernel-space operating system stack DPU virtualization 215. In other examples, memory devices and specialized ASICs can be emulated using a user-space DPU specialized hardware emulation 218 as an application executed in user space of the preinstalled DPU operating system 161.

The DPU firmware 206 can include Trusted Firmware A (TF-A), Unified Extensible Firmware Interface (UEFI) or another publicly available specification that defines a software interface, Advanced Configuration and Power Interface, a power management specification (ACPI) or another power management firmware, and other firmware for the DPU device 109.

The preinstalled DPU operating system 161 can include native DPU functions 209. The native DPU functions 209 can include functionalities that perform network, compute, storage, artificial intelligence, machine learning, and other types of functionalities that are natively provided using the preinstalled DPU operating system 161. The preinstalled DPU operating system 161 can include endpoints through which the native DPU functions 209 can be invoked for use.

The virtual machine environment 212 can provide kernel-space operating system stack DPU virtualization 215 and user-space DPU specialized hardware emulation 218. The kernel-space operating system stack DPU virtualization 215 can provide virtualization for the main processor and other DPU hardware resources 203. However, the additional specialized DPU hardware resources 203 unsupported by the kernel-space operating system stack DPU virtualization 215 can be emulated using user-space DPU specialized hardware emulation 218.

In some examples, the virtual machine environment 212 can include a Power State Coordination Interface (PSCI) interface modelled and provided using the user-space DPU specialized hardware emulation 218. In some examples, this can omit or lack EL3 emulation and TF-A. The virtual machine environment 212 can provide a server based system architecture (SBSA)-like DPU management operating system virtual machine 163. This can include virtualized or emulation-modeled Enhanced Configuration Access Mechanism (ECAM) PCIe, UART, Arm Generic Timer, Generic Interrupt Controller), Advanced Host Controller Interface (AHCI) local storage, NIC functionality, Server Base Boot Requirement (SBBR) firmware (including UEFI and ACPI). PCIe pass-through that matches physical ports can be provided for PCIe ASICs and other PCIe devices such as a CX-6 device.

The DPU management operating system virtual machine 163 can execute on boot or automatically in the startup instructions of the preinstalled DPU operating system 161. The preinstalled DPU operating system 161 can start the components of the virtual machine environment 212 on boot or startup. The DPU management operating system virtual machine 163 can be executed within the virtual machine environment 212 on boot or startup. The components of the DPU management operating system 165 can be compiled to run in EL1. This can include using EL1 variants over EL2 variants for system registers pertaining to MMU, system control, exception handling, generic timer, and interrupt control.

The DPU management operating system virtual machine 163 can include a virtual machine that executes the DPU management operating system 165. DPU management operating system virtual machine 163 can also include SBBR firmware that includes hardware access and power management firmware such as UEFI and ACPI. The DPU management operating system virtual machine 163 can access DPU hardware resources using kernel-space DPU virtualization from the virtual machine environment 212, including one or more of the kernel-space operating system stack DPU virtualization 215 and the user-space DPU specialized hardware emulation 218 facilities.

The DPU management operating system 165 can include management service functions 221. The DPU management operating system 165 can operate in EL1 mode, or kernel level mode, rather than EL2 mode. Exception levels (e.g., EL0, EL1, EL2, EL3) can correspond to Advanced RISC Machine (ARM) privilege levels. EL0 can refer to application mode or user space privilege, EL1 can refer to kernel space or rich operating system privilege, EL2 can refer to hypervisor privilege, and EL3 can refer to firmware kernel space privilege level. The discussion can include reference to exception levels since some DPU devices 109 can include ARM processors as a main processor. However, other DPU devices 109 can include other processor types and privilege levels corresponding to other labels and designations.

The management service functions 221 can include functionalities that are different from the native DPU functions 209. The management service functions 221 can perform management-service-developed network, compute, storage, artificial intelligence, machine learning, management, security, and other types of functionalities that are designed by the management service 120. The DPU management operating system 165 can include or provide endpoints through which the management service functions 221 can be invoked for use.

A DPU management agent 224 can be installed to the preinstalled DPU operating system 161. The DPU management agent 224 can operate much like the management component 151 of the host device 106. Operations described for the management component 151 can be performed by the DPU management agent 224. The DPU management agent 224 executes within the DPU device 109, and can communicate with the management service 120 over the network 112. The DPU management agent 224 can receive commands from the management component 151 and from the management service 120. In some examples, the DPU management agent 224 can check in with a command queue endpoint to retrieve commands to perform. A command queue and corresponding endpoint can be maintained on the host device 106 or on the management system 103.

The DPU management agent 224 can enable the management service 120 to provide updates to the DPU management operating system 165. The DPU management agent 224 can check in with a command queue and retrieve an update command, or can otherwise receive the update command. The update command can include an updated DPU management operating system 165 image or an update installer. Alternatively, the update command can identify an endpoint where the updated DPU management operating system 165 image or update installer can be downloaded. The DPU management agent 224 can perform the update command. The DPU management agent 224 can install an update to the DPU management operating system 165 and restart the DPU management operating system 165 or DPU management operating system virtual machine 163. The DPU management agent 224 can alternatively launch a second DPU management operating system virtual machine 163 that includes an updated DPU management operating system 165, and transfer I/O control to the updated DPU management operating system 165. The pre-existing or previous DPU management operating system virtual machine 163 and DPU management operating system 165 can be terminated and removed, or can remain on the DPU device 109.

Since the DPU management operating system 165 is executed in a virtual machine environment 212 provided by the preinstalled DPU operating system 161, the mechanisms described herein enable management service functions 221 to be invoked and provided using the DPU management operating system 165 while concurrently enabling native DPU functions 209 to be invoked and provided using the DPU management operating system 165.

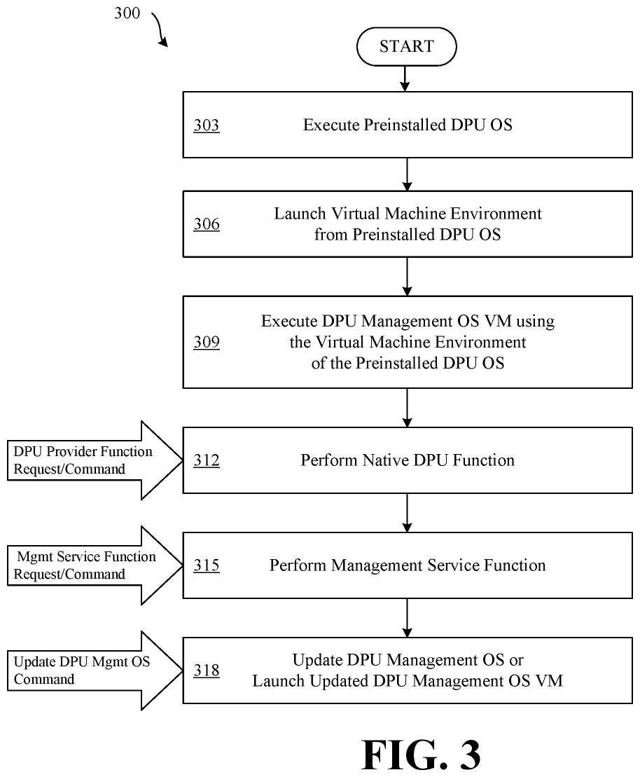

FIG. 3 shows a flowchart 300 that provides an example of the operation of components of the networked environment 100. While a particular step can be discussed as being performed by a particular hardware or software component of the networked environment 100, other components can perform aspects of that step. Generally, this figure provides an example of hosting a DPU management operating system 165 within a virtual machine environment 212 provided using a preinstalled DPU operating system 161. The arrangement involves concurrent execution of the DPU management operating system 165 and the preinstalled DPU operating system 161 rather than replacement of the preinstalled DPU operating system 161 with the DPU management operating system 165. This enables the DPU device 109 to perform management service functions 221 through the DPU management operating system 165 while the native DPU functions 209 remain available to perform using the native or preinstalled DPU operating system 161.

In step 303, the DPU device 109 can execute a preinstalled DPU operating system 161. The preinstalled DPU operating system 161 can include a native operating system that is installed by a third-party such as a provider of the DPU device 109. The preinstalled DPU operating system 161 can include a number of native DPU functions 209 that cause the DPU device 109 to perform actions that are requested. The native DPU functions 209 can include networking, artificial intelligence, machine learning, graphics, and other functionalities. In some examples, an enterprise can desire to install a DPU management operating system 165 while keeping full functionality of the preinstalled DPU operating system 161 and its native DPU functions 209.

In step 306, the DPU device 109 can launch a virtual machine environment 212 within the preinstalled DPU operating system 161. The preinstalled DPU operating system 161 can include a sequence of instructions that launch or configure components of the virtual machine environment 212 on boot or startup. The virtual machine environment 212 can provide kernel-space operating system stack DPU virtualization 215 and user-space DPU specialized hardware emulation 218. The kernel-space operating system stack DPU virtualization 215 can provide virtualization for the main processor and other DPU hardware resources 203. However, the additional specialized DPU hardware resources 203 unsupported by the kernel-space operating system stack DPU virtualization 215 can be emulated using user-space DPU specialized hardware emulation 218.

In step 309, the DPU device 109 can execute the DPU management operating system 165 using the virtual machine environment 212 within the preinstalled DPU operating system 161. The preinstalled DPU operating system 161 can include a sequence of instructions that launch the DPU management operating system 165 within a DPU management operating system virtual machine 163. The virtual machine environment 212 can enable the DPU management operating system virtual machine 163 and the DPU management operating system 165 to access the DPU hardware resources 203.

In step 312, the DPU device 109 can perform a native DPU function 209 using the DPU hardware resources 203. The native DPU function 209 can include network, compute, storage, artificial intelligence, machine learning, and other types of functionalities that are designed by the provider. The preinstalled DPU operating system 161 can include endpoints through which the native DPU functions 209 can be invoked. The DPU device 109 can receive a request that invokes a native DPU function 209 through the preinstalled DPU operating system 161. The DPU device 109 can perform a native DPU function 209 using DPU hardware resources 203 that are accessed using the preinstalled DPU operating system 161. The request can include instructions and parameters that identify a particular native DPU function 209. The request can be submitted to a specific endpoint exposed for a particular native DPU function 209. A management agent executed in the host device 106 or the DPU device 109 can check in with a command queue and retrieve the various requests and commands discussed. This can include the management component 151, the DPU management agent 224, or a management agent executed in the DPU management operating system 165.

In step 315, the DPU device 109 can perform a management service function 221 using the DPU hardware resources 203. The management service function 221 can include management, network, compute, storage, artificial intelligence, machine learning, and other types of functionalities that are designed by the provider. The management service function 221 can include a modified version of a native DPU function 209. The management service function 221 can include a new functionality designed by developers of the management service 120. The management service function 221 can include providing the DPU device 109 and the host device 106 with workloads 130 and enterprise resources and including virtualization resources, databases, files, and other functions that are executed in whole or in part using the management system 103.

The DPU management operating system 165 can include endpoints through which the management service functions 221 can be invoked. The DPU device 109 can receive a request that invokes a management service function 221 through the DPU management operating system 165. The DPU device 109 can perform a management service function 221 using DPU hardware resources 203 that are accessed using the DPU management operating system 165.

In step 318, the DPU device 109 can update the DPU management operating system 165 or launch the updated DPU management operating system virtual machine 163. The DPU management agent 224 can receive or identify an update command. The update command can include or identify a download location for an updated DPU management operating system 165 image or an update installer.

The DPU management agent 224 can install an update to the DPU management operating system 165. In some examples, the DPU management agent 224 can restart the DPU management operating system 165 or DPU management operating system virtual machine 163. The DPU management agent 224 can alternatively launch a second DPU management operating system virtual machine 163 that includes the updated DPU management operating system 165. The DPU management agent 224 can transfer I/O control to the updated DPU management operating system 165. In some examples, the pre-existing or previous DPU management operating system virtual machine 163 and DPU management operating system 165 can be terminated and removed.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory devices can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although the various services and functions described herein can be embodied in software or code executed by general purpose hardware as discussed above, as an alternative, the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagrams and flowcharts can show examples of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or another system. The machine code can be converted from the source code. If embodied in hardware, each block can represent a circuit or a number of interconnected circuits to implement the specified logical function(s).

Although sequence diagrams and flowcharts can be shown in a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted.

Also, any logic or application described herein that includes software or code can be embodied in any non-transitory computer-readable medium for use by or in connection with an instruction execution system such as a processor in a computer system or another system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described embodiments of the present disclosure are merely possible examples of implementations described for a clear understanding of the principles of the disclosure. Many variations and modifications can be made to the above-described embodiments without departing substantially from the spirit and principles of the disclosure. All such modifications and variations are intended to be included in the following claims herein, within the scope of this disclosure.

Therefore, the following is claimed:

1. A non-transitory computer-readable medium comprising executable instructions, wherein the instructions, when executed by at least one processor, cause at least one computing device to at least:
execute, by a data processing unit (DPU) device, a preinstalled DPU operating system that is installed on the DPU device by a third party;
provide, by the DPU device, a virtual machine environment using the preinstalled DPU operating system;
execute, by the DPU device, a DPU management operating system within the virtual machine environment provided using the preinstalled DPU operating system; and
perform, by the DPU device, at least one of: a native DPU function performed using DPU hardware resources accessed through the preinstalled DPU operating system, or a management service function using the DPU hardware resources accessed through the DPU management operating system and the virtual machine environment.

2. The non-transitory computer-readable medium of claim 1, wherein the instructions, when executed by the at least one processor, cause the at least one computing device to at least:
receive, by the DPU device, a request to perform the at least one of the native DPU function, or the management service function.

3. The non-transitory computer-readable medium of claim 1, wherein the virtual machine environment comprises a user-space hardware emulation component that provides access to at least one of the DPU hardware resources.

4. The non-transitory computer-readable medium of claim 1, wherein the virtual machine environment comprises a kernel-space virtualization component that is part of an operating system stack of the preinstalled DPU operating system.

5. The non-transitory computer-readable medium of claim 1, wherein the virtual machine environment comprises a privileged virtual machine.

6. The non-transitory computer-readable medium of claim 1, wherein the native DPU function comprises at least one of: a network function, a graphics function, a machine learning function, and an artificial intelligence function.

7. The non-transitory computer-readable medium of claim 1, wherein the management service function is performed at least in part by a computing environment of a management service accessed over a network.

8. A system, comprising:
at least one computing device comprising at least one processor; and
a data store comprising executable instructions, wherein the instructions, when executed by the at least one processor, cause the at least one computing device to at least:
execute, by a data processing unit (DPU) device, a preinstalled operating system installed on the DPU device;
provide, by the DPU device, a virtual machine environment using the preinstalled operating system;
execute, by the DPU device, a DPU management operating system within the virtual machine environment provided using the preinstalled operating system; and
perform, by the DPU device, at least one of: a native DPU function performed using DPU hardware resources accessed through the preinstalled operating system, or a management service function using the DPU hardware resources accessed through the DPU management operating system and the virtual machine environment.

9. The system of claim 8, wherein the instructions, when executed by the at least one processor, cause the at least one computing device to at least:
receive, by the DPU device, a request to perform the at least one of the DPU provider function, or the management service function.

10. The system of claim 8, wherein the virtual machine environment comprises a user-space hardware emulation component that provides access to at least one of the DPU hardware resources.

11. The system of claim 8, wherein the virtual machine environment comprises a kernel-space virtualization component that is part of an operating system stack of the preinstalled operating system.

12. The system of claim 8, wherein the virtual machine environment comprises a privileged virtual machine.

13. The system of claim 8, wherein the native DPU function comprises at least one of: a network function, a graphics function, a machine learning function, and an artificial intelligence function.

14. The system of claim 8, wherein the management service function is performed at least in part by a computing environment of a management service accessed over a network.

15. A method, comprising:
executing, by a data processing unit (DPU) device, a preinstalled operating system that is installed on the DPU device;
providing, by the DPU device, a virtual machine environment using the preinstalled operating system;
executing, by the DPU device, a DPU management operating system within the virtual machine environment provided using the preinstalled operating system; and
performing, by the DPU device, at least one of: a third-party DPU function performed using DPU hardware resources accessed through the preinstalled operating system, or a management service function using the DPU hardware resources accessed through the DPU management operating system and the virtual machine environment.

16. The method of claim 15, further comprising:
receiving, by the DPU device, a request to perform the at least one of the third-party DPU function, or the management service function.

17. The method of claim 15, wherein the virtual machine environment comprises a user-space hardware emulation component that provides access to at least one of the DPU hardware resources.

18. The method of claim 15, wherein the virtual machine environment comprises a kernel-space virtualization component that is part of an operating system stack of the preinstalled operating system.

19. The method of claim 15, wherein the virtual machine environment comprises a privileged virtual machine.

20. The method of claim 15, wherein the third-party DPU function comprises at least one of: a network function, a graphics function, a machine learning function, and an artificial intelligence function.
